(19) United States
(12) Patent Application Publication
(10) Pub. No.: US 2005/0281020 A1
(43) Pub. Date: Dec. 22, 2005

(54) Battery charger for water-resistant flashlight

(76) Inventors: Suh Jang Liaw, Taichung City (TW); Dih Shuen Liaw, Taichung City (TW)

Correspondence Address: Keith Kline;PRO-TECHTOR INTERNATIONAL SERVICES, 20775 Norada Court, Saratoga, CA, 95070-3018, US

(21) Appl. No.: 10/870,867

(22) Filed: Jun. 16, 2004

(51) Int. Cl. F21L 7/00

(52) U.S. Cl. 362/157

(57) ABSTRACT

A water-resistant flashlight is provided and comprises a rear charging socket and two side grooves. A battery charger comprises two side rails, a rear socket, and two contacts. Sliding the rails along the grooves until the contacts contact the charging socket will form a charging loop from the charging socket, a negative terminal of a rechargeable battery, a connecting assembly to a positive terminal of the battery. Subsequently inserting a plug of an external power source such as an AC adapter, a generator for bicycle, or a magnetoelectric device into the socket will charge the flashlight through the battery charger.

### FIELD OF THE INVENTION

The present invention relates to water-resistant flashlights and more particularly to such a water-resistant flashlight having an improved battery charger.

### BACKGROUND OF THE INVENTION

It is known that a type of water-resistant flashlight having a rechargeable battery is available. Conventionally, a charging socket is formed at the end of the water-resistant flashlight and the charging socket is electrically coupled to a rechargeable battery. One end of the battery charger is adapted to insert into the charging socket for charging the rechargeable battery if the battery is low. However, the charging socket is subject to leakage (i.e., not water-resistant) and thus corrosion may occur in the flashlight if the flashlight was exposed to or immersed in water. Thus, continuing improvements in the exploitation of the battery charger for a water-resistant flashlight are constantly being sought.

### SUMMARY OF THE INVENTION

It is an object of the present invention to provide a water-resistant flashlight comprising a main body including a forward illumination assembly, a switch, a compartment for receiving a rechargeable battery, a rear charging socket having two external contacts and two internal contacts, and two side grooves; a connecting assembly disposed in the main body and including a first contact electrically coupled to a negative terminal of the rechargeable battery, a second contact electrically coupled to a positive terminal of the rechargeable battery, and a third contact wherein the illumination assembly is adapted to turn on by sliding the switch in one direction to contact the third contact; a control unit disposed in the main body and adapted to either light or flash the enabled illumination assembly; and a battery charger including two side rails, rear socket means, and two contact members disposed between the rails and the socket means; whereby sliding the rails along the grooves until the contacts members contact the external contacts will form a charging loop from the external contact, the internal contact, the negative terminal, the first contact, and the second contact to the positive terminal, and inserting a plug of an external power source into the socket means will charge the flashlight through the battery charger. a battery charger for water-resistant flashlight comprising By utilizing the present invention, because the flashlight including the charging socket is water-resistant, the flashlight is suitable for underwater use.

The above and other objects, features and advantages of the present invention will become apparent from the following detailed description taken with the accompanying drawings.

### BRIEF DESCRIPTION OF THE DRAWINGS

FIG. 1 is a perspective view of a water-resistant flashlight to be coupled to a battery charger according to the invention;

FIG. 2 is a side view in part section of the flashlight and the battery charger;

FIG. 3 is a sectional view of the coupled flashlight and battery charger; and

FIGS. 4, 5 and 6 schematically depict the coupled flashlight and battery charger to be charged by one of three external power sources including an AC adapter, a generator for bicycle, and a magnetoelectric device respectively.

### DETAILED DESCRIPTION OF THE PREFERRED EMBODIMENTS

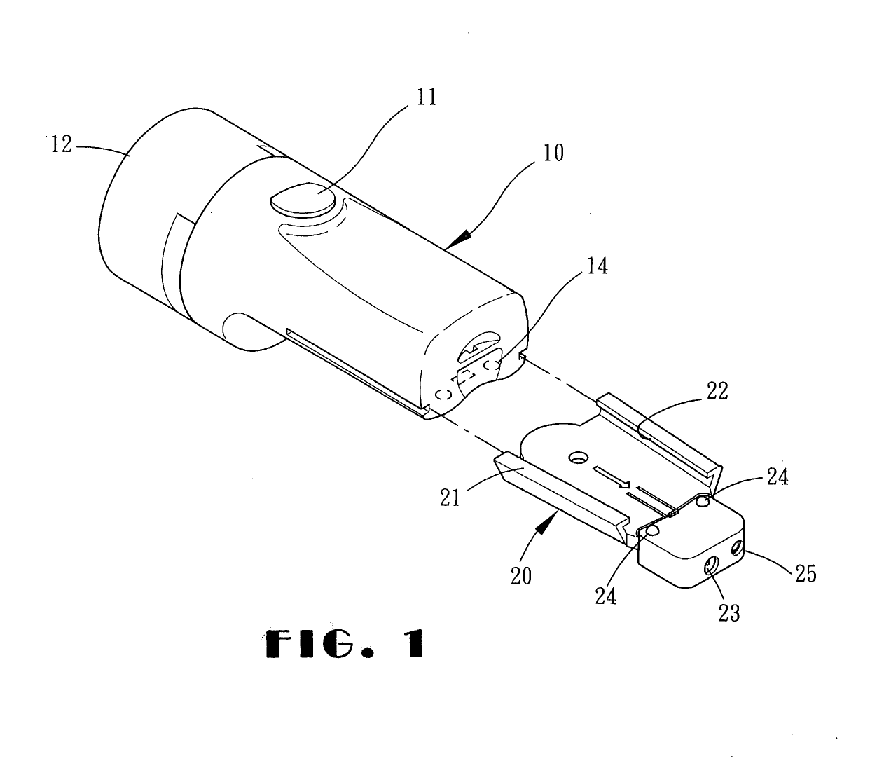

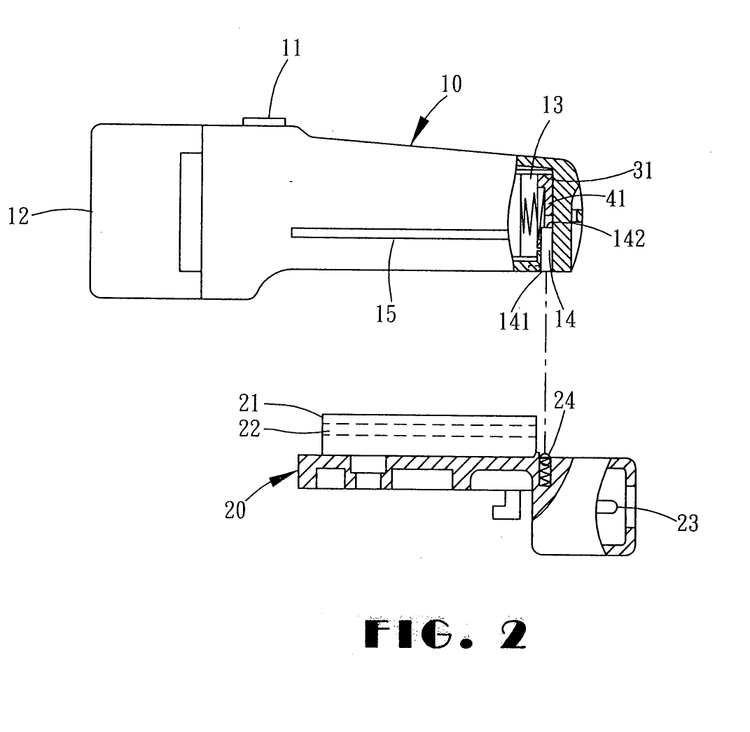

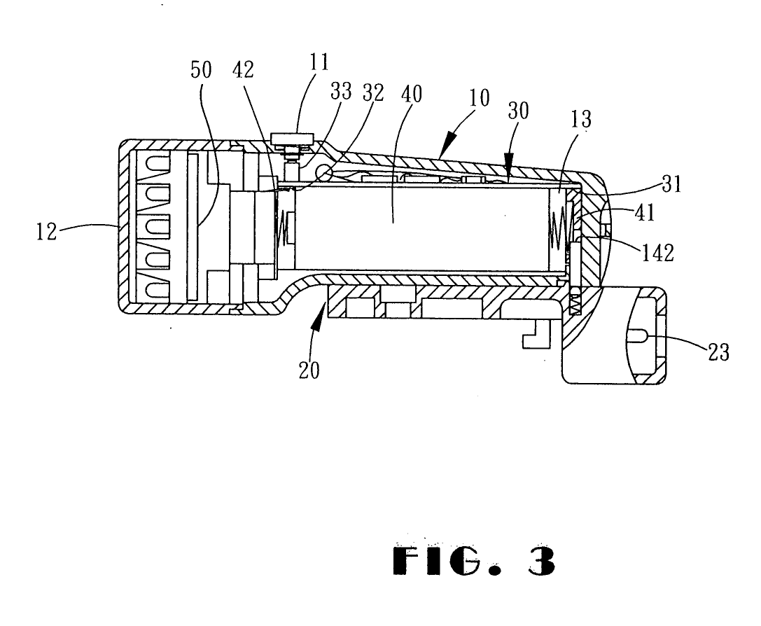

Referring to FIGS. 1 to 3, there is shown a substantially cylindrical water-resistant flashlight 10 constructed in accordance with the invention comprising a forward illumination assembly 12 including one or more LEDs (light-emitting diodes), a switch 11 provided on an outer surface for enabling or disabling the illumination assembly 12, a water-resistant internal space 13 for receiving a rechargeable battery 40, a water-resistant rear charging socket 14 including two external contacts 141 on a rear end of the flashlight 10 and two internal contacts 142, and two side grooves 15.

An elongated battery charger 20 for charging the flashlight 10 comprises two side rails 21, two slides 22 formed by the rails 21, a socket 23 at a rear end, a charging indicator 25 adjacent the socket 23, and two contacts 24 provided between the rails 21 and the socket 23.

A connecting assembly 30 comprises a first contact 31 electrically coupled to a negative terminal 41 of the rechargeable battery 40, a second contact 32 electrically coupled to a positive terminal 42 of the rechargeable battery 40, and a third contact 33. The illumination assembly 12 can be turned on by sliding the switch 11 in one direction to contact the third contact 33. A control unit 50 is adapted to, for example light or flash the illumination assembly 12 when the illumination assembly 12 is enabled.

For connecting the battery charger 20 to the flashlight 10, a user may slide the slides 22 along the grooves 15 until the contacts 24 contact the external contacts 141. At this position, a charging loop (i.e., from the external contact 141, the internal contact 142, the negative terminal 41, the first contact 31, and the second contact 32 to the positive terminal 42) is formed.

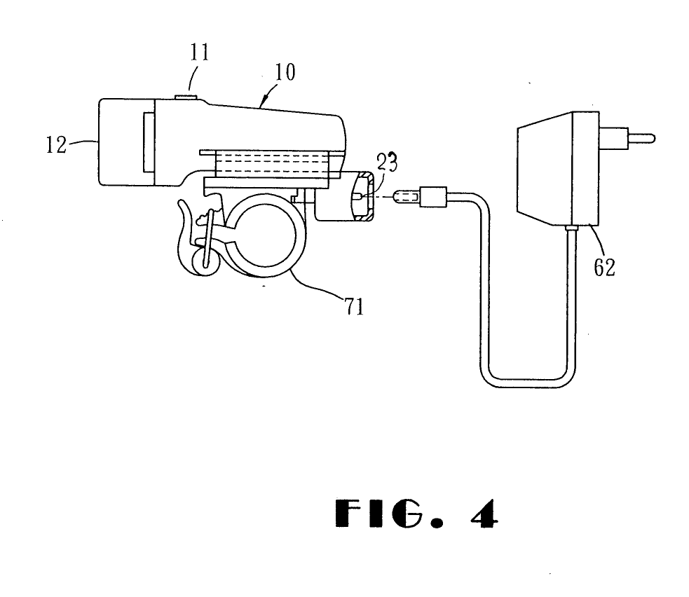

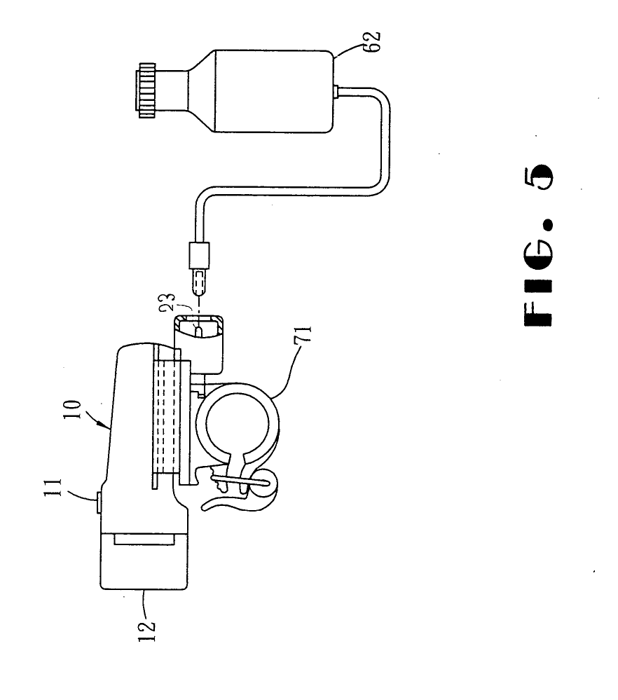

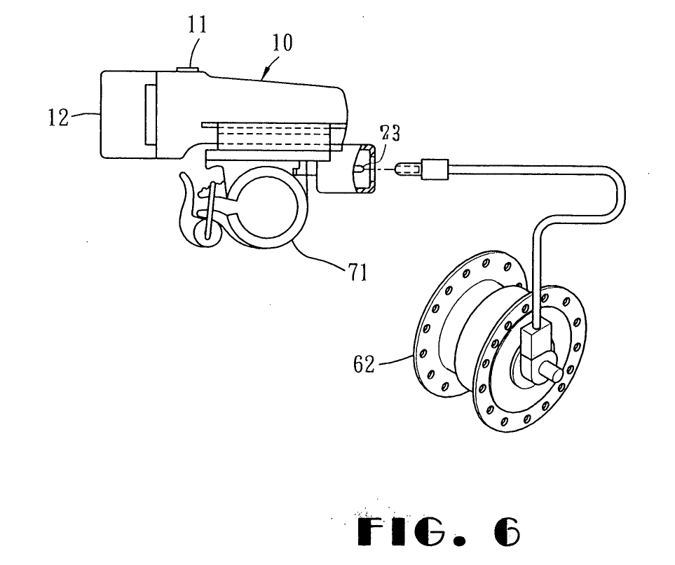

Referring to FIGS. 4, 5, and 6, charging operations of the flashlight 10 will be described below. The coupled flashlight 10 and battery charger 20 are mounted on a seat 71. Next, a user may insert a plug of an AC adapter 62 (see FIG. 4), a generator for bicycle 62 (see FIG. 5), or a magnetoelectric device 62 (see FIG. 6) into the socket 23 for charging the flashlight 10 through the battery charger 20. Advantageously, because the flashlight 10 including the charging socket 14 is water-resistant, the flashlight 10 is suitable for underwater use.

While the invention herein disclosed has been described by means of specific embodiments, numerous modifications and variations could be made thereto by those skilled in the art without departing from the scope and spirit of the invention set forth in the claims.

1. A water-resistant flashlight comprising:
a main body including a forward illumination assembly, a switch, a compartment for receiving a rechargeable battery, a rear charging socket having two external contacts and two internal contacts, and two side grooves;
a connecting assembly disposed in the main body and including a first contact electrically coupled to a negative terminal of the rechargeable battery, a second contact electrically coupled to a positive terminal of the rechargeable battery, and a third contact wherein the illumination assembly is adapted to turn on by sliding the switch in one direction to contact the third contact;
a control unit disposed in the main body and adapted to either light or flash the enabled illumination assembly; and
a battery charger including two side rails, rear socket means, and two contact members disposed between the rails and the socket means;
whereby sliding the rails along the grooves until the contacts members contact the external contacts will form a charging loop from the external contact, the internal contact, the negative terminal, the first contact, and the second contact to the positive terminal, and inserting a plug of an external power source into the socket means will charge the flashlight through the battery charger.

2. The flashlight of claim 1, wherein the illumination assembly comprises one or more LEDs.

3. The flashlight of claim 1, wherein the battery charger further comprises a charging indicator disposed adjacent the socket means.

4. The flashlight of claim 1, wherein the external power source is an AC adapter, a generator for bicycle, or a magnetoelectric device.

5. The flashlight of claim 1, further comprising a seat for fastening the coupled flashlight and the battery charger thereon.
